(19) United States
(12) Patent Application Publication
(10) Pub. No.: US 2006/0079361 A1
(43) Pub. Date: Apr. 13, 2006

(54) Endless metal belt and its maufacturing method and continuously variable transmission

(75) Inventors: Yasushi Ueda, Toyota-shi (JP); Ichiro Aoto, Toyota-shi (JP); Yuji Suzuki, Toyota-shi (JP); Ryoichi Hibino, Nagoya-shi (JP); Masataka Osawa, Nagoya-shi (JP); Masashi Hattori, Anjo-shi (JP); Katsumori Fujii, Anjo-shi (JP); Ryo Nakamura, Tahara-shi (JP)

Correspondence Address: OLIFF & BERRIDGE, PLC, P.O. BOX 19928, ALEXANDRIA, VA, 22320, US

(73) Assignees: Toyota Jidosha Kabushiki Kaisha, Toyota-shi (JP); Aisin AW Co., Ltd., Anjo-shi (JP)

(21) Appl. No.: 11/247,237

(22) Filed: Oct. 12, 2005

(30) Foreign Application Priority Data
Oct. 13, 2004 (JP) 2004-299049

(51) Int. Cl. F16G 5/00; F16H 55/56

(52) U.S. Cl. 474/201; 474/8

(57) ABSTRACT

The first element has a first thickness. The second element has a second thickness that is smaller than the first thickness, and the number of second elements is approximately equal to that of the first elements. Both the first and second elements are supported by the hoop so as to stack in the thickness direction according to a maximum length sequence.

### INCORPORATION BY REFERENCE

The disclosure of Japanese Patent Application No. 2004-299049 filed on Oct. 13, 2004 including the specification, drawings and abstract is incorporated herein by reference in its entirety.

### BACKGROUND OF THE INVENTION

1. Field of the Invention

The invention relates to an endless metal belt and its manufacturing method, as well as a continuously variable transmission. In particular, the invention relates to an endless metal belt with a plurality of thickness elements.

2. Description of the Related Art

A conventional endless metal belt is disclosed, for example, in Japanese Patent No. 2532253.

In Japanese Patent No. 2532253, art is disclosed in which two or more types of elements are randomly arranged in order to reduce noise.

However, the random arrangement of elements alone does not necessarily have an adequate noise reduction effect.

### SUMMARY OF THE INVENTION

The invention was devised in light of the foregoing problem, and it is an object of the invention to provide an endless metal belt and its manufacturing method, as well as a continuously variable transmission, which are capable of adequately reducing noise and vibration.

The endless metal belt according to the invention is provided with a circular body and a plurality of first and second elements made of metal which are fitted to the circular body. The first element has a first thickness. The second element has a second thickness smaller than the first thickness, and the number of second elements is approximately equal to that of the first elements. Both the first and second elements are supported by the circular body so as to stack in the thickness direction according to a maximum length sequence.

In the endless metal belt structured as described above, a more random arrangement of the first and second elements is assured because the first and second elements are stacked in the thickness direction according to a maximum length sequence. Consequently, vibration and noise caused by the elements can be reduced. Furthermore, the use of a maximum length sequence makes it possible to easily decide the arrangement of the first and second elements by calculation.

The maximum length sequence will be described here. A maximum length sequence is a method for generating highly precise random numbers on a long-term basis. After setting the initial value N, the kth (>N) value is determined based upon the initial value N. The kth number becomes 0 when N=7, and the values for k-Nth and k−1th are equal. Conversely, the kth number becomes 1 when the value for k-Nth and the value for k−N+1th are different.

More specifically, if the initial value N (=7) is set to 0000001, then the 1st to 7th numbers 0000001 are obtained from the initial value. To set the number for k=8th, the 1st (=k−N=8−7) and the 7th (=k−1=8−1) numbers are referred to. Since the 1st number is 0 and the 7th number is 1, the 8th number becomes 1. Hence, the arrangement of the maximum length sequence is determined in this manner. Based upon such an arrangement, it is possible, for example, to dispose the first elements at a “0” position and dispose the second elements at a “1” position, thus randomly disposing the first and second elements according to a maximum length sequence arrangement.

Note that with regards to the initial value of the maximum length sequence, if the initial value N is set to 7 for example, only an arrangement of 27−1=127 can be determined, although it is possible to create an arrangement over 127 by repeating this arrangement.

The manufacturing method for an endless metal belt according to the invention is a manufacturing method for an endless belt that is provided with a plurality of first and second elements made of metal which are fitted to a circular body. The first element has a first thickness. The second element has a second thickness that is smaller than the first thickness, and the number of second elements is approximately equal to that of the first elements. Both the first and second elements are supported by the circular body so as to stack in the thickness direction. The manufacturing method includes the processes of: making a plurality of endless metal belt samples by stacking the first and second elements in the thickness direction according to a plurality of random number sets; assembling each of the plurality of endless metal belts samples to the continuously variable transmission and measuring the noise during driving; and mass-producing endless metal belts based upon a random number used to stack the first and second elements in the endless metal belt sample with the least amount of noise among the plurality of endless metal belt samples.

According to the manufacturing method for an endless metal belt structured as described above, the endless metal belt can be mass-produced based upon a random number capable of minimizing noise from among a plurality of random number sets. Consequently, an endless metal belt with reduced noise can be provided.

A continuously variable transmission according to the invention uses the endless metal belt described above.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a cross-sectional view of a belt-type continuously variable transmission according to a first embodiment of the invention;

FIG. 2 is a partial perspective view for describing an endless metal belt;

FIG. 3 is a perspective view of the endless metal belt;

FIG. 4 is a front view of an element;

FIG. 5 is a graph showing noise generated by the endless metal belt with first and second elements alternately stacked;

FIG. 6 is a graph showing noise generated by the endless metal belt with the first elements and the second elements arranged grouped together;

FIG. 7 is a graph showing noise generated by the endless metal belt with the first and second elements arranged according to a maximum length sequence;

FIG. 8 is a graph showing noise generated by the endless metal belt with only the first elements stacked;

FIG. 9 is a graph showing noise generated when the first and second elements are disposed according to random numbers; and

FIG. 10 is a block diagram showing a manufacturing method for the endless metal belt according to a second embodiment.

### DETAILED DESCRIPTION OF THE PREFERRED EMBODIMENTS

Hereinafter, embodiments of the invention will be described with reference to the drawings. Note that in the following embodiments, like reference numerals are used for like or equivalent portions and descriptions therefor are not repeated.

### First Embodiment

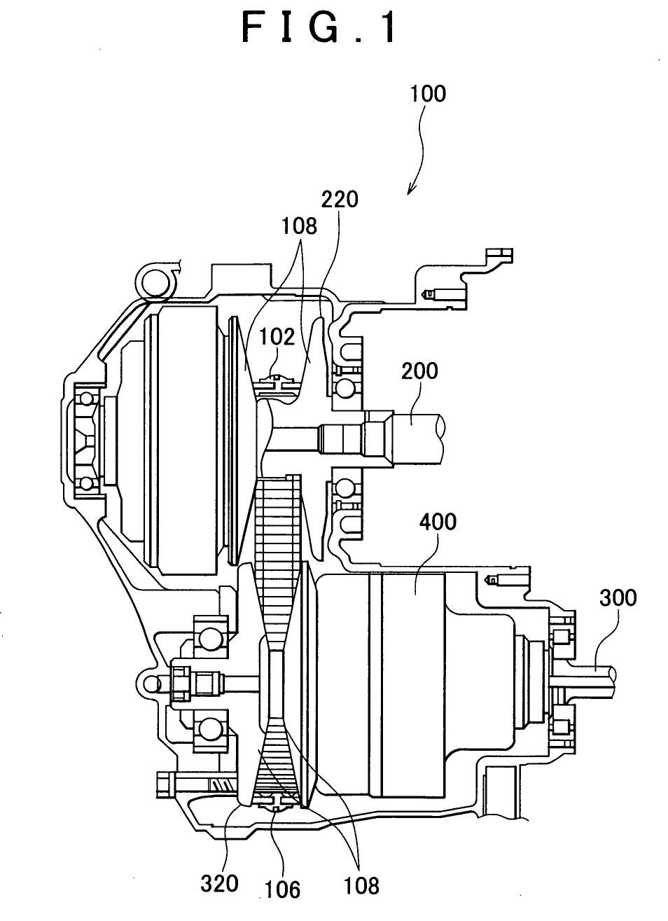

FIG. 1 is a cross-sectional view of a belt-type continuously variable transmission according to a first embodiment of the invention. A belt-type continuously variable transmission 100 according to the first embodiment of the invention will be described with reference to FIG. 1. In the belt-type continuously variable transmission 100, an endless metal belt 106 is wound around an input pulley 220 attached to an input shaft 200 and an output pulley 320 attached to an output shaft 300. Also provided in the belt-type continuously variable transmission 100 is an assist portion 400 that provides additional clamping force to the output pulley 320 to counter rotation fluctuations received by the output shaft 300 from a drive wheel.

The input pulley 220 and the output pulley 320 are respectively provided with a pair of sheaves 108 whose groove widths may be continuously varied. Varying the groove widths using a hydraulic pressure circuit that is controlled depending on the vehicle running state also varies the winding radius of the endless metal belt 106 with respect to the input pulley 220 and the output pulley 320. It is therefore possible to change the rotational speed ratio between the input shaft 200 and the output shaft 300, i.e., the gear ratio, in a continuous and stepless manner.

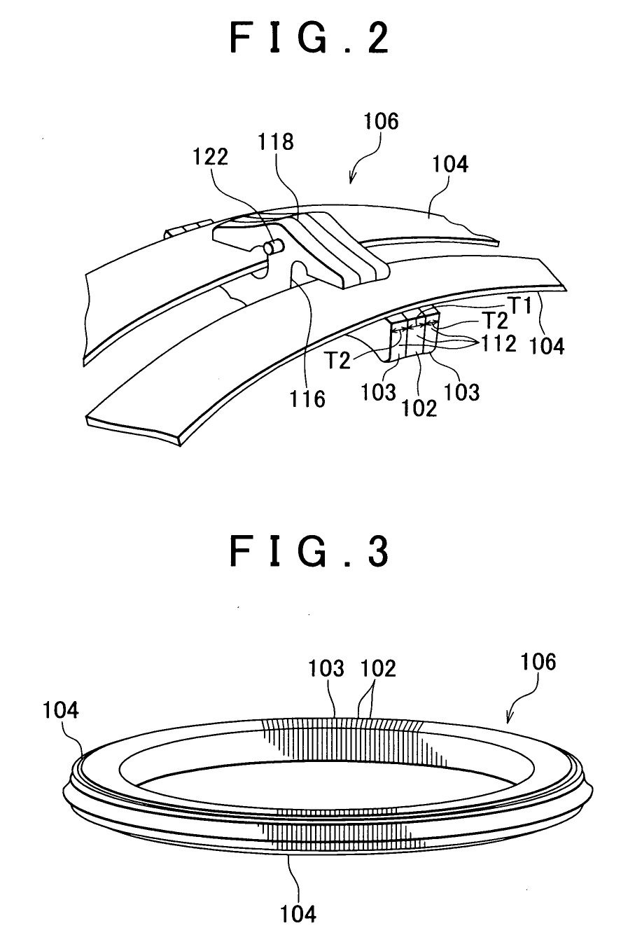

FIG. 2 is a partial perspective view for describing an endless metal belt. Referring to FIG. 2, the endless metal belt 106 has first elements 102 and second elements 103 that are disposed mutually and circularly aligned in the thickness direction. The overall endless metal belt 106 is structured by running hoops 104, which are circular metal bands, through right and left saddle portions of the elements 102, 103 to bind the elements 102, 103. The hoops 104 are flexible metal members that serve as bands structuring the endless metal belt 106. The first and second elements 102, 103 are supported between two hoops. In addition, the first element 102 has a first thickness T1, while the second element 103 has a second thickness T2.

FIG. 3 is a perspective view of the endless metal belt. Referring to FIG. 3, the endless metal belt 106 has a circular shape and is structured by randomly arranging the first elements 102 and the second elements 103 along the hoops 104.

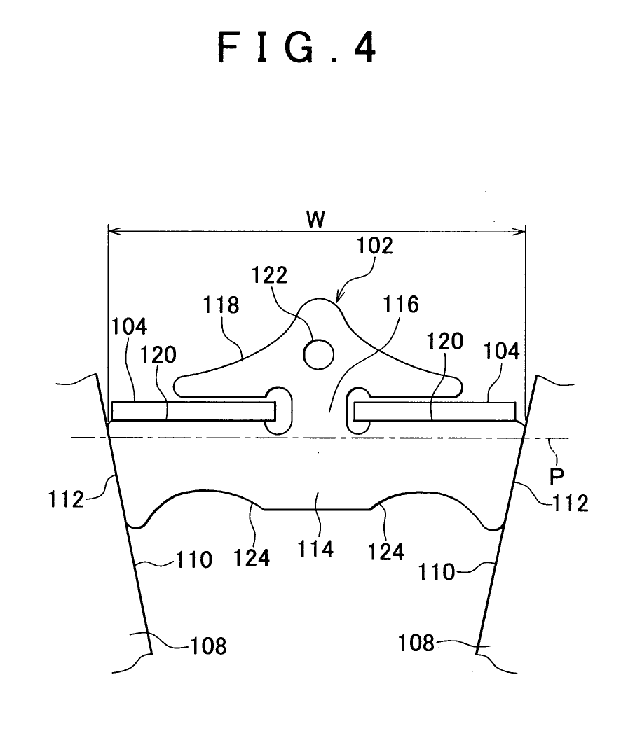

FIG. 4 is a front view of an element. Referring to FIG. 4, the side faces on both ends of the first element 102 in the width direction are a pair of sheave frictional faces 112. The sheave frictional face 112 is in contact with a tapered sheave face 110 on the sheave 108, and is a face tapered to conform to the sheave face 110. A base portion 114 provided with the pair of sheave frictional faces 112 has a neck portion 116 formed at a central portion thereof in the width direction. The neck portion 116 extends toward an upper side in FIG. 4, and is connected to a head portion 118 that extends rightward and leftward. Formed between the base portion 114 and the head portion 118 extending rightward and leftward are right and left slits through which the hoops 104 are passed. A face of the base portion 114 in contact with the hoop 104 is a saddle face 120.

The height of the saddle face 120 is represented as a dimension from a pitch line P that traverses the base portion 114. Furthermore, the width of the element 102 is represented as a dimension above the pitch line P. Note that a dimple hole 122, with one side face convex while the other side face is concave, is formed at an extension position of the neck portion 116 among the head portion 118. Dimple holes 122 of mutually adjacent first and second elements 102, 103 are designed to fit together. Also note that the convex portion of the dimple hole 122 is on the front face of the element, while the concave portion is on the back face of the element. In addition, the first and second elements 102, 103 have a width W, and the widths of the first and second elements 102, 103 are approximately equal. The number of first and second elements 102, 103 is also approximately equal.

The endless metal belt 106 is clamped between the pair of sheaves 108. Since the sheave face 110 and the corresponding sheave frictional face 112 are tapered faces, a load due to the clamping force from the sheave 108 acts on the outer sides of each element in the radial direction. However, movement of each element toward the outer side in the radial direction is restricted by the tensile force of the hoops 104, because the elements 102 are bound by the hoops 104. As a result, friction force or oil film shearing force is generated between the sheave face 110 and the corresponding sheave frictional face 112 to transmit torque between the sheave 108 and the endless metal belt 106.

Thus, a load pressing each element 102 outward in the radial direction is generated due to the sheave 108 clamping the endless metal belt 106. This clamping force of the sheave 108 is controlled by a hydraulic circuit separately provided. If the tires lock after lightly stepping on the brake while driving a vehicle on a low μ road where the road surface subsequently turns into asphalt, a control device controls the hydraulic circuit based on certain driving conditions (e.g., changes in output shaft rotational speed) so that the endless metal belt 106 does not slip between the pair of frictional faces 112 and sheaves 108 due to fluctuation of torque transmitted from the tires or transmission speed control.

In this manner, a load is added to the first and second elements 102, 103 while the first and second elements run around the sheaves 108. Consequently, while the first and second elements 102, 103 are running, they vibrate and generate noise. In the invention, the first and second elements 102, 103 are disposed according to a maximum length sequence in order to reduce such noise. In other words, the endless metal belt 106 according to the invention is provided with the hoop 104 that is a circular body, and a plurality of first and second elements 102, 103 made of metal that are fitted to the circular hoop 104. The first element 102 has the first thickness T1. The second element 103 has the second thickness T2 that is smaller than the first thickness T1, and the number of second elements 103 is approximately equal to that of the first elements 102. Both the first and second elements 102, 103 are supported by the hoop 104 so as to stack in the thickness direction according to a maximum length sequence.

Namely, in order to reduce noise and vibration caused by the metal belt of the continuously variable transmission, first and second elements 102, 103 having different thicknesses are used. Furthermore, prescribing the arrangement of the first and second elements 102, 103 having different thicknesses can lead to a further reduction in the noise level. More specifically, the first and second elements 102, 103 are disposed according to a maximum length sequence.

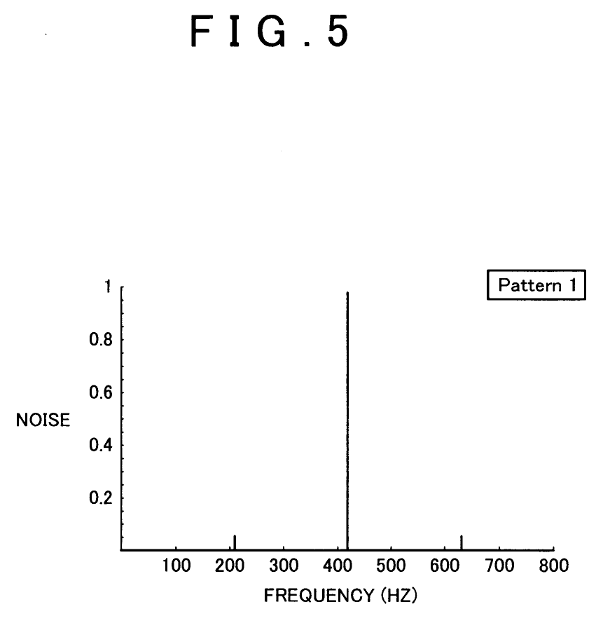

FIG. 5 is a graph showing noise generated by the endless metal belt with the first and second elements alternately stacked. Referring to FIG. 5, the endless metal belt 106 is structured by alternately arranging a total of 420 first elements 102 having a thickness of 1.80 mm and second elements 103 having a thickness of 1.65 mm. Namely, the thicknesses of 1.80 mm (0) and 1.65 mm (1) are disposed one after the other. When the endless metal belt 106 is driven in the continuously variable transmission, a pattern of noise such as shown in FIG. 5 is generated. Such noise has a peak near a frequency of 400 Hz, and it is evident that noise of a specific frequency is being generated. In addition, the magnitude of noise is shown by the scale on the vertical axis, from which it is clear that a loud noise is being generated.

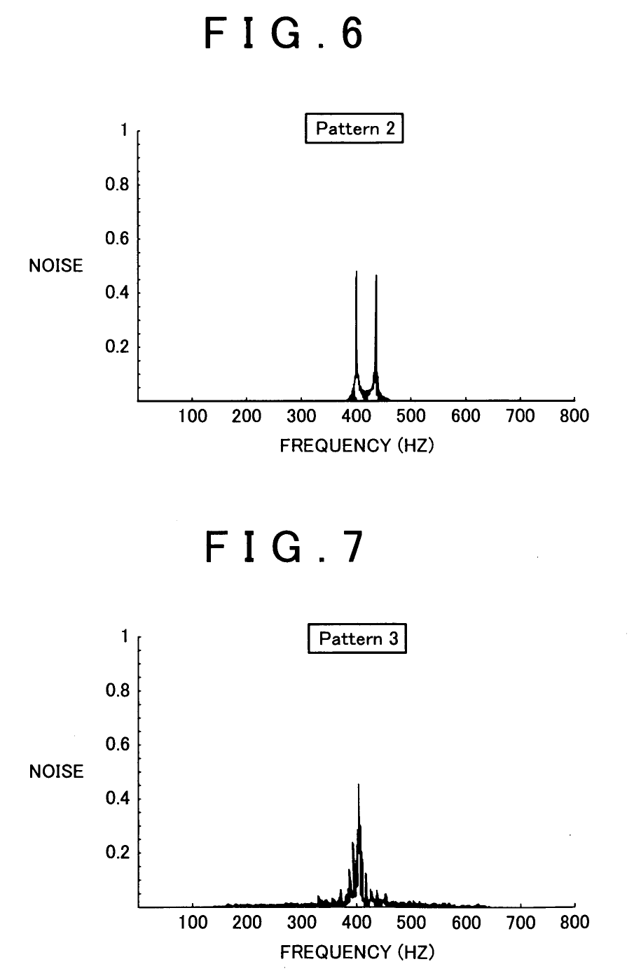

FIG. 6 is a graph showing noise generated by the endless metal belt with the first elements and the second elements arranged grouped together. Of the 420 elements, in FIG. 6, the first elements 102 (with a 1.80 mm thickness) make up the former half, while the remaining second elements 103 (with a 1.65 mm thickness) make up the latter half. As shown in FIG. 6, two frequency peaks are apparent. Because the two frequencies are adjacent, a swell corresponding to the frequency difference is generated. Therefore, even if elements with two different thicknesses are used, a uniform layout of the elements generates noise of two frequencies which causes discomfort in the driver.

FIG. 7 is a graph showing noise generated by the endless metal belt with the first and second elements arranged according to a maximum length sequence. Referring to FIG. 7, only one peak appeared with a peak value even smaller than the noise shown in FIG. 5. Moreover, it was possible to suppress the generation of swells compared to FIG. 6, because there was no plurality of large peaks. According to such results, noise can be reduced by arranging the first and second elements 102, 103 according to a maximum length sequence.

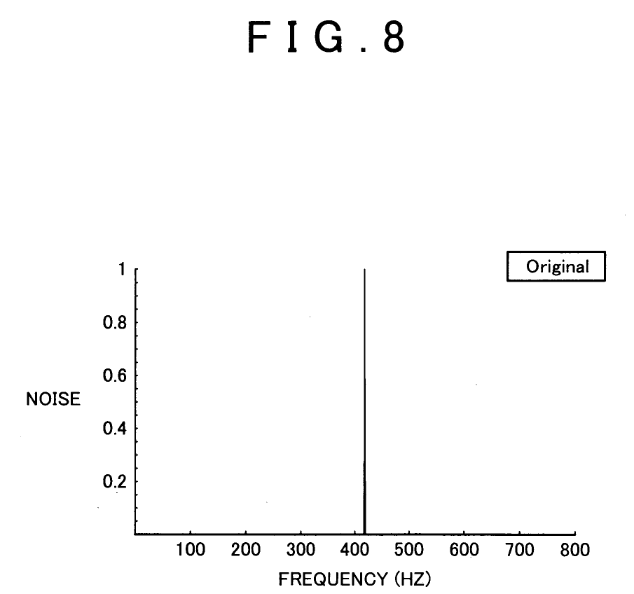

FIG. 8 is a graph showing noise generated by the endless metal belt with only the first elements stacked. Referring to FIG. 8, it was found that one sharp peak appears when the endless metal belt 106 is structured with only the first elements 102. Also note that the vertical axes in FIGS. 5 to 7 indicate the magnitude of noise in each sample with respect to the noise in FIG. 8.

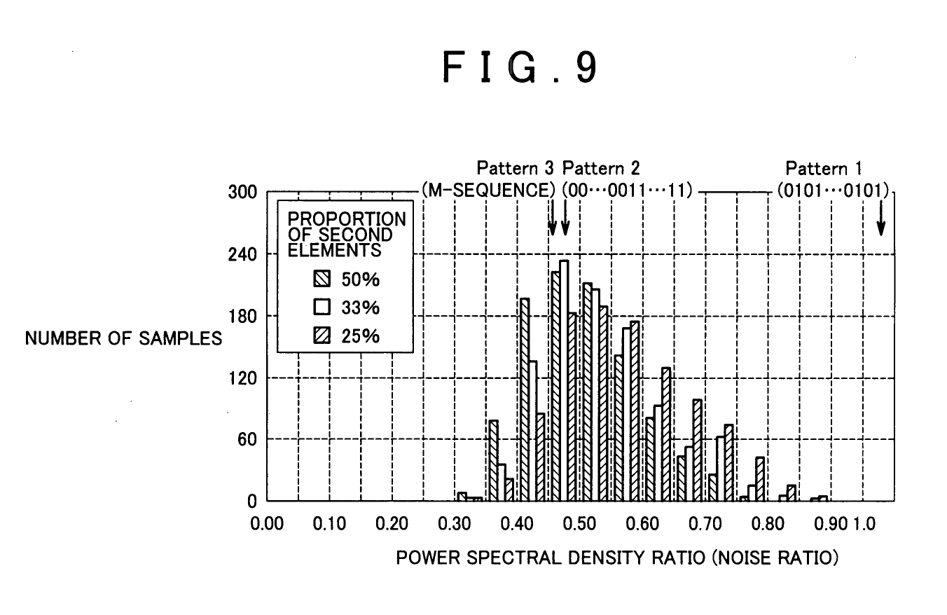

FIG. 9 is a graph showing noise generated when the first and second elements are disposed according to random numbers. The horizontal axis in FIG. 9 indicates the noise ratio representing noise generated in each sample and each noise becomes louder as it approaches the right side in the graph. The noise ratio indicates the magnitude of noise for each sample with respect to the magnitude of noise shown in FIG. 8. The vertical axis in FIG. 9 indicates the number of samples found for each noise ratio.

One thousand samples of endless metal belts were made in which an equal proportion of first elements 102 and second elements 103 were arranged according to various random numbers. There were a total of 420 first and second elements 102, 103 in each sample. Noise for the 1,000 samples was measured. A noise ratio was calculated by comparing the peak values of the measured noise to the noise generated in the original sample (the sample in FIG. 8, i.e., the endless metal belt structured from only first elements 102 with a thickness of 1.80 mm). In FIG. 9, bars in the graph with hatching that slopes downward to the right indicate the number of samples found for each noise ratio when each sample has the second element proportion of 50%. Also, in FIG. 9, non-hatched bars indicate the equivalent number of samples for another 1000 samples each having the second element proportion of 33%, and bars with hatching that slopes downward to the left indicate the equivalent number of samples for still another 1000 samples each having the second element proportion of 25%.

According to FIG. 9, it is apparent that there are variations in the noise ratio even when the first and second elements 102, 103 are arranged based upon random numbers. The noise ratios are also found for the samples in patterns 1 to 3 shown in FIGS. 5 to 7, respectively. As shown in FIG. 9, the noise ratio for the sample of pattern 3 (maximum length sequence) is relatively small, and found to achieve a satisfactory noise characteristic.

In other words, according to the invention, belt noise can be whitened by mixing the first and second elements 102, 103, which have two types of thicknesses, to generate frequency modulations. Although there are variations caused by deciding the order at random, the degree of noise whitening is increased by using a mix ratio of around 50%. Furthermore, the application of a maximum length sequence to arrange the first and second elements 102, 103 allows for stable whitening of belt noise.

With regard to the graphs, there is a peak frequency in the intermediate vicinity of the frequencies of the first elements 102 with a 1.80 mm thickness and the second elements 103 with a 1.65 mm thickness when there is adequate whitening as in the maximum length sequence of pattern 3. In pattern 2, the peaks of both the first elements 102 and the second elements 103 are apparent.

### Second Embodiment

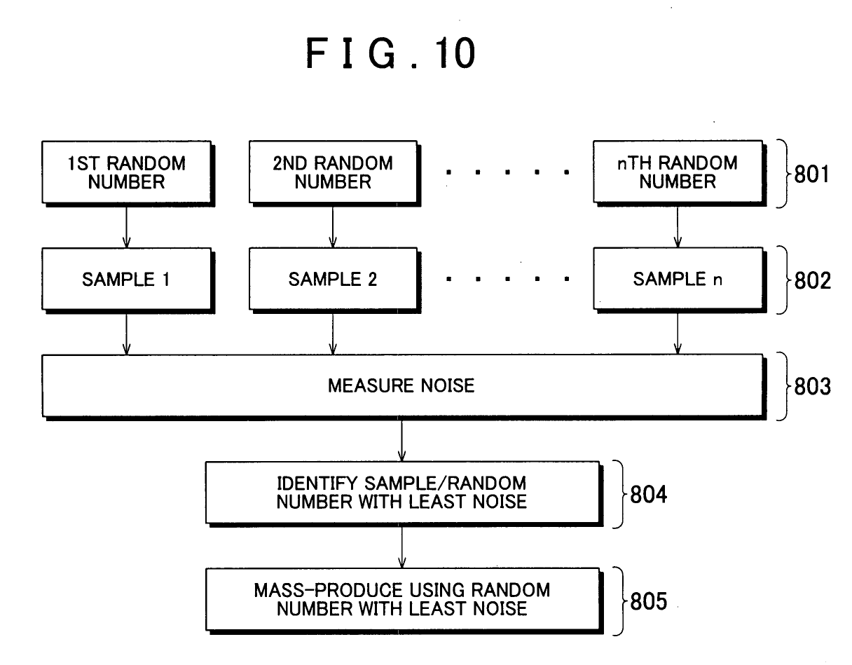

In a second embodiment, another method is used to minimize noise. FIG. 10 is a block diagram showing a manufacturing method for the endless metal belt according to the second embodiment. In the second embodiment, various random numbers are generated, and actual samples are made based upon these random numbers. By measuring the sample noise, random numbers capable of minimizing noise were found.

Referring to FIG. 10, first in step 801 an n amount of random numbers are generated from a 1st random number up to an nth random number. Physical random numbers and pseudo-random numbers can be used for this random number generating method. Furthermore, methods based upon a linear congruence method or a maximum length sequence may also be employed as methods for generating pseudo-random numbers. Also, the random numbers are random numbers using an arrangement of zeros and ones.

Next in step 802, samples 1 to n are made respectively corresponding to the random numbers. The first elements 102 with large thicknesses are disposed corresponding to zeros in the random numbers, while the second elements 103 with small thicknesses are arranged corresponding to ones. In this manner, endless metal belt samples 1 to n are made by disposing the first and second elements 102, 103 according to random numbers. In each of the samples, the number of first and second elements 102, 103 is approximately equal.

Subsequently in step 803, the samples are assembled to the belt-type continuously variable transmission to measure the noise when the samples are actually driven. When measuring noise, the operating condition of the continuously variable transmission may be set to various conditions. Next in step 804, the noise of the samples 1 to n are analyzed to identify the sample with the least amount of noise. Thus, the random number capable of minimizing noise can also be identified in turn.

In step 805, mass-production is carried out for the endless metal belt 106, which has the first and second elements 102, 103 arranged based upon the random number found in step 804 that minimizes noise.

Accordingly, the manufacturing method for an endless metal belt according to the second embodiment of the invention, for example, can be applied as a manufacturing method for the endless belt 106 that is provided with a plurality of first and second elements 102, 103 made of metal that are fitted to the hoop 104, which is a circular body. The first element 102 has the first thickness T1. The second element 103 has the second thickness T2 that is smaller than the first thickness T1, and the number of second elements 103 is approximately equal to that of the first elements 102. Both the first and second elements 102, 103 are supported by the hoop 104 so as to stack in the thickness direction. The manufacturing method includes the processes of: making a plurality of endless metal belt samples by stacking the first and second elements 102, 103 in the thickness direction according to a plurality of random number sets (steps 801, 802); assembling each of the plurality of endless metal belts to the continuously variable transmission and measuring the noise during driving (step 803); and mass-producing endless metal belts based upon a random number used in the arrangement of first and second elements in the endless metal belt with the least amount of noise among the plurality of endless metal belt samples (steps 804, 805).

According to the manufacturing method for an endless metal belt structured as described above, the first and second elements are arranged based upon a random number that minimizes noise. Therefore, it is possible to provide an endless metal belt capable of suppressing the generation of noise to the utmost extent.

Embodiments of the invention were described above, however, various modifications of the embodiments specified here are possible. For example, the thicknesses of the first and second elements in the first embodiment were specified as 1.80 mm and 1.65 mm. However, the thicknesses are not particularly limited to this, and various element thicknesses and widths may be employed. Moreover, it is also possible to set an element width (belt width: W in FIG. 4) to 30 mm, with the thickness of the first element 102 as 1.80 mm and the thickness of the second element 103 as 1.65 mm.

In addition, the belt width W may be set to 24 mm, with the thickness T1 of the first element 102 set to 1.50 mm and the thickness T2 of the second element 103 set to 1.40 mm.

While the invention has been described with reference to exemplary embodiments thereof, it is to be understood that the invention is not limited to the exemplary embodiments or constructions. To the contrary, the invention is intended to cover various modifications and equivalent arrangements other than described above. In addition, while the various elements of the exemplary embodiments are shown in various combinations and configurations, which are exemplary, other combinations and configurations, including more, less or only a single element, are also within the spirit and scope of the invention.

What is claimed is:

1. An endless metal belt comprising:
a circular body; and
a plurality of first elements made of metal and second elements made of metal, whose number is approximately equal to the number of the first elements, the first elements and the second elements being fitted to the circular body, each of the first elements having a first thickness, each of the second elements having a second thickness smaller than the first thickness, and the first and second elements being supported by the circular body to stack in a thickness direction of the first and second elements according to a maximum length sequence.

2. A manufacturing method for an endless metal belt that is provided with a plurality of first and second elements made of metal and fitted to a circular body, wherein the first element has a first thickness, the second element, whose number is approximately equal to the first element, has a second thickness smaller than the first element, and the first and second elements are supported by the circular body so as to stack in a thickness direction of the first and second elements, comprising:
making a plurality of endless metal belt samples by stacking the first and second elements in the thickness direction according to a plurality of random number sets;
assembling each of the plurality of endless metal belt samples to the continuously variable transmission and measuring the noise during driving; and
mass-producing endless metal belts based upon a random number used in the stacking of the first and second elements in the endless metal belt with the least amount of noise among the plurality of endless metal belt samples.

3. A continuously variable transmission using the endless metal belt (106) according to claim 1.

4. A continuously variable transmission using the endless metal belt manufactured by the manufacturing method according to claim 2.
